(19) United States
(12) Patent Application Publication
(10) Pub. No.: US 2014/0040935 A1
(43) Pub. Date: Feb. 6, 2014

(54) MULTI-SCREEN TARGETED ADVERTISING

(71) Applicants: Nader Gharachorloo, Ossining, NY (US); Afshin Moshrefi, Newburyport, MA (US)

(72) Inventors: Nader Gharachorloo, Ossining, NY (US); Afshin Moshrefi, Newburyport, MA (US)

(73) Assignee: VERIZON PATENT AND LICENSING INC., Basking Ridge, NJ (US)

(21) Appl. No.: 13/562,722

(22) Filed: Jul. 31, 2012

(51) Int. Cl. H04N 21/236

(52) U.S. Cl. 725/23

(57) ABSTRACT

A system provides, to consumers, coupon offers that correspond to television advertising seen by the consumer. The system may receive tracking information of a television advertisement presented to a user of a particular set-top box, and identify, from a group of stored coupon content, particular coupon content corresponding to the television advertisement. Based on stored delivery preferences for the user, the system sends the particular coupon content to a user device (e.g., a smart phone, computer, etc.) associated with the set-top box.

### BACKGROUND

Television broadcasts may include segments reserved for local advertising, which is typically inserted by a service provider. It is preferred to target inserted advertising for particular consumers viewing the television broadcasts.

Digital coupons have proved to be an effective technique for attracting consumers to particular merchants. Particularly, some merchants participate in coupon programs that offer discounts only upon an assurance that a minimum number of consumers will join in the offer. However, coupon offers that are provided to consumers who have no familiarity with the offering merchant may tend to have poor consumer participation rates.

### BRIEF DESCRIPTION OF THE DRAWINGS

FIG. 1 is a diagram illustrating concepts described herein;

FIG. 2 is a diagram illustrating an exemplary network in which systems and/or methods described herein may be implemented;

FIG. 3 is a block diagram of exemplary components of a device that may correspond to one of the devices of FIG. 2 according to one implementation;

FIG. 4 is a block diagram of exemplary components of a device that may correspond to one of the devices of FIG. 2 according to another implementation;

FIG. 5 is a block diagram of exemplary communications among devices in a portion of the network of FIG. 2 according to one implementation;

FIG. 6 is a block diagram of exemplary communications among devices in a portion of the network of FIG. 2 according to another implementation;

FIGS. 7A-7C are diagrams of exemplary user interfaces for targeted coupon delivery;

FIG. 8 is a flowchart of an exemplary process for providing information to support targeted coupons, according to an implementation described herein; and

FIG. 9 is a flowchart of an exemplary process for providing targeted coupons to a user device, according to an implementation described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may provide, to a consumer, targeted coupon offers that correspond to television advertising seen by the consumer. In one implementation, the systems and/or methods may receive tracking information of a television advertisement presented to a user of a particular set-top box, and identify, from a group of stored coupon content, particular coupon content corresponding to the television advertisement. Based on stored delivery preferences, the systems and/or methods may send the particular coupon content to a user device (e.g., a smartphone, a computer, etc.) associated with the set-top box.

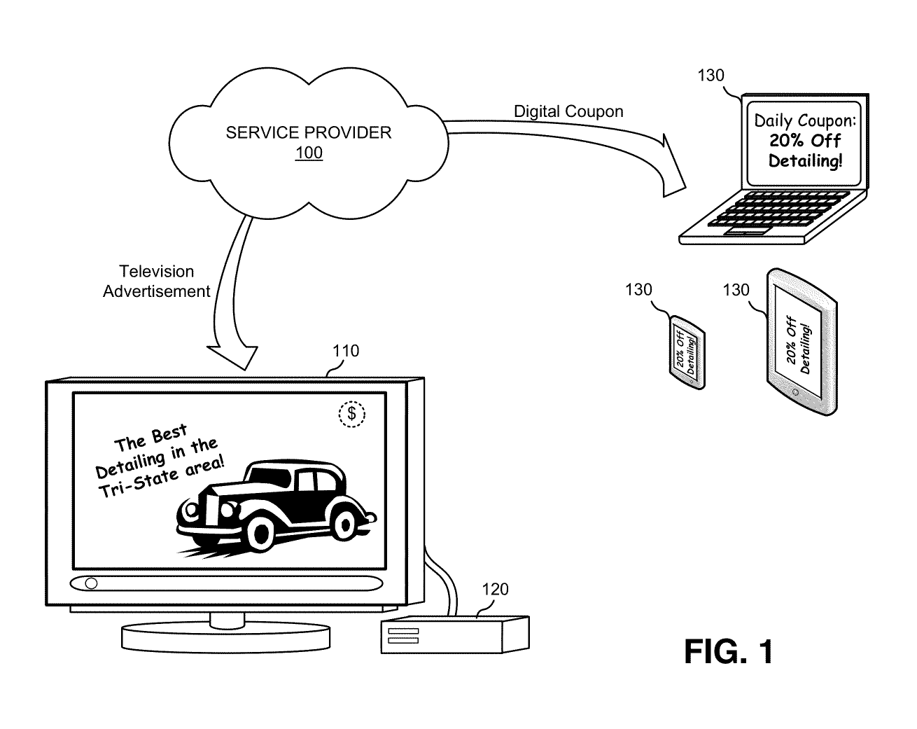

FIG. 1 is a diagram illustrating concepts described herein. As shown in FIG. 1, a service provider 100 may provide television content that includes advertisements to a user's television 110. In some implementations, the television content may be processed through a set-top box (STB) 120 (sometimes referred to as a media client) that enables television 110 set to receive and decode television signals from service provider 100 and provides an interface to communicate with service provider 100. Viewers of television 110 may be presented with advertisements included, for example, during breaks in programing content. In some cases, advertisements may be targeted to particular geographic regions or to particular STBs 120 (e.g., based on a known user profile).

Service provider 100 may also provide a distribution service for digital coupons. For example, service provider 100 may provide digital coupons to user devices 130 or accounts associated with user devices 130. Digital coupons may include, for example, discount offers from participating third-party companies. The digital coupons may, for example, be used as sales promotion tools to accomplish specific sales and marketing goals for the third-party companies. In one implementation, the digital coupons may include a code or link that may be used for an on-line transaction. In other implementations, the digital coupons may be printed and/or presented for redemption at a local store.

Customer response to the digital coupons may be more effective when the digital coupons are provided to people who have some familiarity with the third-parties' products or services that are promoted via the digital coupon. According to an implementation described herein, service provider 100 may track television advertising actually presented to viewers (e.g., viewers that opt-in to a coupon distribution program) via television 110/STB 120 and deliver digital coupons (e.g., to user devices 130) for products that have been previously introduced to the viewer via television advertising. For example, service provider 100 may use backend servers and/or local STBs 120 to log times/channels actually tuned to by STB 120 and identify advertising presented on those channels at the particular time of viewing. Service provider 100 may then match coupon offers based on advertising that has been presented.

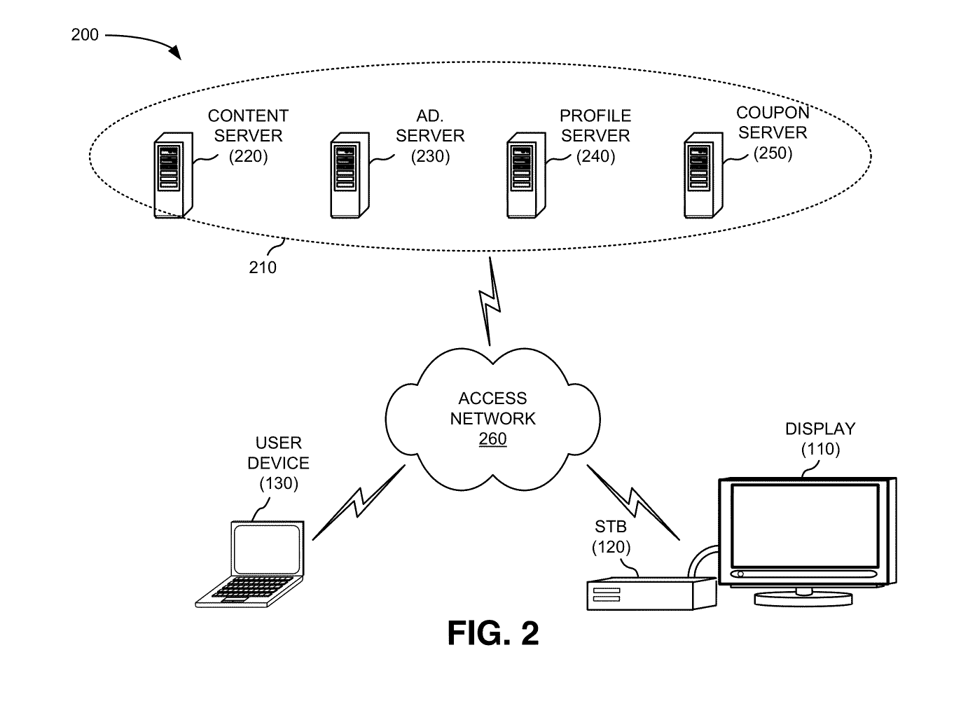

FIG. 2 is an exemplary network 200 in which systems and/or methods described herein may be implemented. As illustrated, network 200 may include display 110, STB 120, user device 130, and a service provider network 210 interconnected by an access network 260. Service provider network 210 may include a content server 220, an advertising server 230, a profile server 240, and a coupon server 250. Components of network 200 may be connected via wired and/or wireless links. A single display 110, STB 120, user device 130, service provider network 210, content server 220, advertising server 230, profile server 240, coupon server 250, and access network 260 are shown in FIG. 2 for simplicity. In practice, network 200 may include multiple displays 110, STBs 120, user devices 130, service provider networks 210, content servers 220, advertising servers 230, profile servers 240, coupon servers 250, and/or access networks 260.

Display 110 may include a digital or analog display via which a user may view multimedia content (including, for example, conventional programming, interactive displays, and/or advertising). Display 110 may refer to any device that can receive and display multimedia content delivered over access network 260 and/or through STB 120 for perception by users. Display 110 may include television technologies such as cathode ray tube (CRT) displays, liquid crystal displays (LCDs), light-emitting diode (LED) displays, plasma displays, etc.

STB 120 may include a device capable of receiving, transmitting and/or processing information to and/or from service provider network 210. In one implementation, STB 120 may be a closed device (e.g., including a hardware/software configuration that is not accessible to the general public) with a unique identifier (e.g., a serial number) that can be used to associate a particular STB with a particular customer/location. STB 120 may provide video signals to display 110. In various implementations, STB 120 may include a set-top box, a computer, a cable card, and a portable electronic device (e.g., a cell phone, a personal digital assistant (PDA), etc.). STB 120 may receive a television signal from access network 260, may convert the signal to a form usable by display 110, and may transmit the signal to display 110 for presentation to a user. STB 120 may further allow a user to provide user input for interactive television applications (e.g., to navigate menu displays and/or select menu items) and to alter the programming provided to display 110 based on a signal (e.g., a channel up or channel down signal) received from, for example, a remote control. In one implementation, STB 120 may support user interfaces, such as coupon selection interfaces described herein, using Enhanced TV Binary Interchange Format (EBIF). STB 120 may also send data to a backend server (e.g., content server 220, advertising server 230, profile server 240, coupon server 250, etc.) via access network 260. In some implementations, STB 120 may be incorporated within display 110 or another device.

User device 130 may include a computational or communication device. User device 130 may enable a user to send/receive messages, view content, and/or interact with other devices. For example, user device 210 may include a tablet computer, a personal computer, a smart phone, a personal gaming system, a global positioning system (GPS) unit, a touch-enabled television display, or other types of computational or communication devices that can receive signals via access network 260.

Service provider network 210 may include network devices to manage equipment and/or services, such as telecommunications equipment/services, to customers. Service provider network 210 may include a local area network (LAN), an intranet, a private wide area network (WAN), etc. In one implementation, service provider network 210 may implement one or more network connections or Virtual Private Network (VPN) connections for providing communication between, for example, any of content server 220, advertising server 230, profile server 240, and/or coupon server 250. In one implementation, service provider network 210 may be protected/separated from other networks, such as access network 260, by a firewall. Although shown as a single element in FIG. 2, service provider network 210 may include a number of separate networks.

Content server 220 may include one or more server devices that store and/or distribute content, such as video content, that may be delivered to STB 120. The content may include, for example, television broadcasts, video-on-demand programming, or other video content into which advertising segments may be inserted. The content may be stored and/or made available, by content server 220 in real-time or near real-time, relative to the time of the original content event. In one implementation, content server 220 may provide different content simultaneously to the same STB 120.

Advertising server 230 may include one or more network devices, or other types of computational or communication devices, that store advertising content that may be delivered to STB 120. The advertising content may include, for example, television advertising content and metadata that allows the advertising content to be associated with particular groups, categories, and/or profiles. The advertising content may include, for example, a unique identifier for each particular advertisement. In one implementation, advertising server 230 may provide advertising content to STB 120 upon request from STB 120. In another implementation, advertising server 230 may provide advertising content for insertion into a content stream from content server 220 based on queues from content server 220.

Profile server 240 may include one or more network devices, or other types of computational or communication devices, to store user profile information of users (e.g., users of STB 120). The user profile information may include various information regarding a user, such as login information (e.g., a user identifier and a password), billing information, address information, types of services to which the user has subscribed, a list of digital content purchased by (or given to) the user, an STB identifier (e.g., for STB 120), user device identifier(s) (e.g., for user device 130), and various user preferences, tendencies, or the like. In implementations described herein, profile server 240 may include an opt-in/opt-out selection for a coupon distribution program and/or a coupon delivery preference.

Coupon server 250 may include one or more network devices, or other types of computational or communication devices, that store coupon content that may be delivered to STB 120 and/or user devices 130. Coupon content may include discount offers from merchants or other participating third parties (e.g., businesses participating with a service provider of service provider network 210). Coupon content may include, for example, coupon text (e.g., HTML content), coupon images, codes (e.g., bar codes, quick response (QR) codes, etc.), and/or coupon metadata relating to particular discount offers. Coupon metadata may include, for example, data indicating a particular merchant, time periods of an offer, a product category, a product name, etc. In one implementation, coupon content may also include information to permit association with a particular television advertisement. For example, coupon content may include (e.g., in coupon metadata) a unique identifier for a particular television advertisement (e.g., on advertising server 230) with which the coupon content may be matched. In one implementation, coupon content available on coupon server 250 may include coupons connected with regional daily deals (e.g., offers that are available only if a predetermined minimum number of participants join in).

Access network 260 may include a local area network (LAN); an intranet; the Internet; a wide area network (WAN), such as a cellular network, a satellite network, a fiber optic network, a private WAN, or a combination of the Internet and a private WAN; etc., that is used to transport data. Although shown as a single element in FIG. 2, access network 260 may include a number of separate networks that function to provide services to, for example, STB 120 and user device 130.

Although FIG. 2 shows exemplary components of network 200, in other implementations, network 200 may include fewer components, different components, differently arranged components, or additional components than those depicted in FIG. 2. Alternatively, or additionally, one or more components of network 200 may perform one or more other tasks described as being performed by one or more other components of network 200.

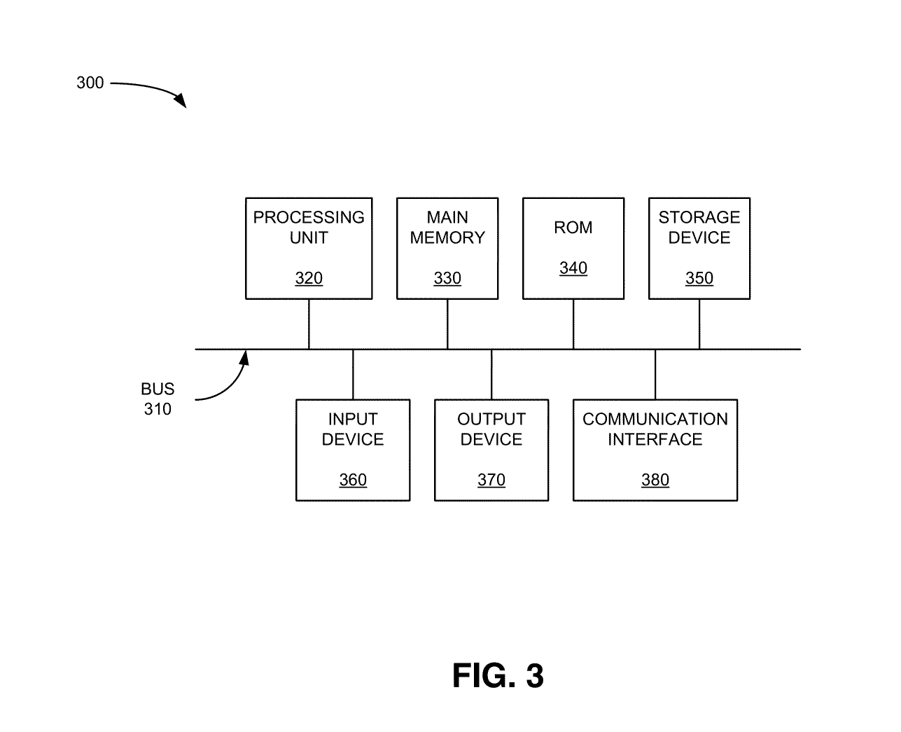

FIG. 3 is a diagram of exemplary components of a device 300. Each of STB 120, user device 130, content server 220, advertising server 230, profile server 240, or coupon server 250 may be implemented/installed as software, or a combination of hardware and software, on one or more devices 300. As shown in FIG. 3, device 300 may include a bus 310, a processing unit 320, a main memory 330, a ROM 340, a storage device 350, an input device 360, an output device 370, and a communication interface 380.

Bus 310 may permit communication among the components of device 300. Processor 320 may include one or more processors or microprocessors that interpret and execute instructions. In other implementations, processing unit 320 may be implemented as or include one or more application specific integrated circuits (ASICs), field programmable gate arrays (FPGAs), or the like.

Main memory 330 may include a RAM or another type of dynamic storage device that may store information and instructions for execution by processing unit 320. ROM 340 may include a ROM device or another type of static storage device that may store static information and/or instructions for use by processing unit 320. Storage device 350 may include a magnetic and/or optical recording medium and its corresponding drive.

Input device 360 may include a device that permits an operator to input information to device 300, such as a keyboard, a keypad, a mouse, a pen, a microphone, a touch screen, one or more biometric mechanisms, and the like. Output device 370 may include a device that outputs information to the operator, such as a display, a speaker, etc.

Communication interface 380 may include any transceiver-like mechanism that enables device 300 to communicate with other devices and/or systems. For example, communication interface 380 may include mechanisms for communicating with other devices, such as other devices of service provider network 210.

As described herein, device 300 may perform certain operations in response to processing unit 320 executing software instructions contained in a computer-readable medium, such as main memory 330. A computer-readable medium may include a non-transitory memory device. A memory device may be implemented within a single physical memory device or spread across multiple physical memory devices. The software instructions may be read into main memory 330 from another computer-readable medium or from another device via communication interface 380. The software instructions contained in main memory 330 may cause processing unit 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows exemplary components of device 300, in other implementations, device 300 may include fewer components, different components, differently arranged components, or additional components than those depicted in FIG. 3. As an example, in some implementations, a display may not be included in device 300. In these situations, device 300 may be a “headless” device that does not include input device 360. Alternatively, or additionally, one or more components of device 300 may perform one or more other tasks described as being performed by one or more other components of device 300.

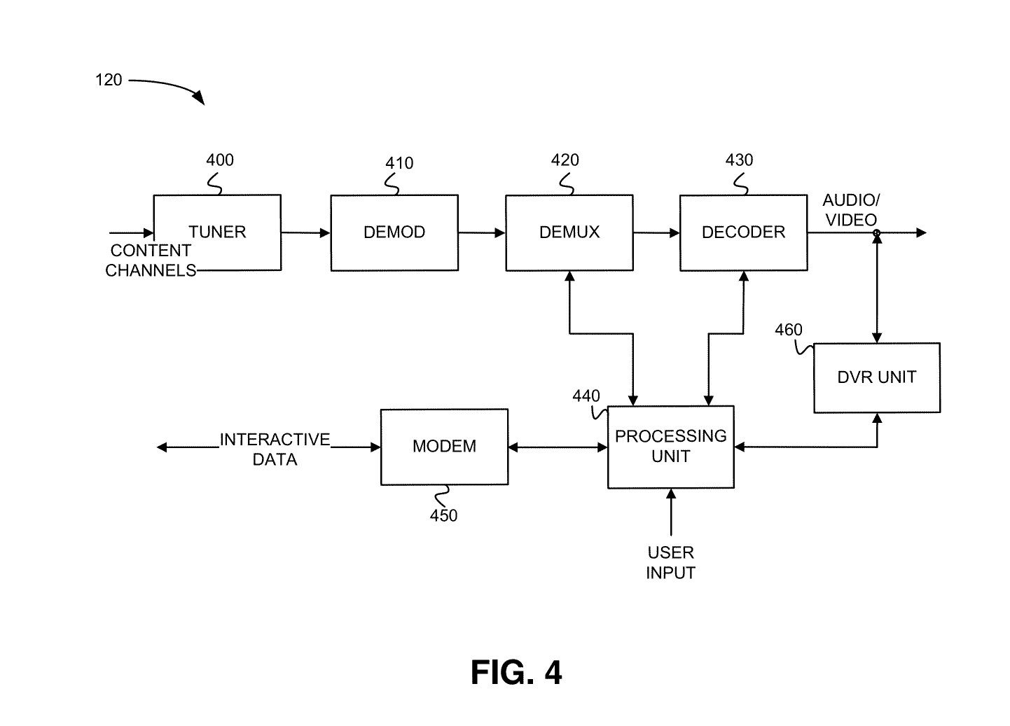

FIG. 4 depicts exemplary components of STB 120 according to another implementation. STB 120 may include a tuner 400, a demodulator 410, a demultiplexer 420, a decoder 430, a processing unit 440, a modem 450, and a DVR unit 460. Tuner 400 may select and tune to specific broadcast television information by tuning to one of many different input channels. Each channel may be digitally modulated using, for example, Quadrature Amplitude Modulation (QAM), though other types of modulation may be used. Demodulator 410 may demodulate the information in the channel selected by tuner 400 to produce a transport stream (e.g., MPEG-2 or MPEG-4 transport stream) containing the audio, video and/or other information related to a selected TV program.

Demultiplexer 420 may select and decrypt compressed audio and video from the transport stream for the particular TV program that the device user wishes to watch. Decoder 430 may decode and decompress the decrypted audio and video information for the selected TV program. Processing unit 440 may include, for example, a microprocessor that controls the operations performed by tuner 400, demodulator 410, demultiplexer 420, decoder 430, modem 450 and DVR unit 460 based on user input (e.g., input received from a device user 100 via a remote control device). Modem 450 may send and receive data (e.g., advertisement metadata and/or advertisement insertion data) that may be processed by processing unit 440. DVR unit 460 may digitally record, and store, audio and video content associated with the particular TV program decoded by decoder 430.

The configuration of components of STB 120 in FIG. 4 is for illustrative purposes only. Other configurations may be implemented. STB 120 may include additional, fewer and/or different components than those depicted in FIG. 4.

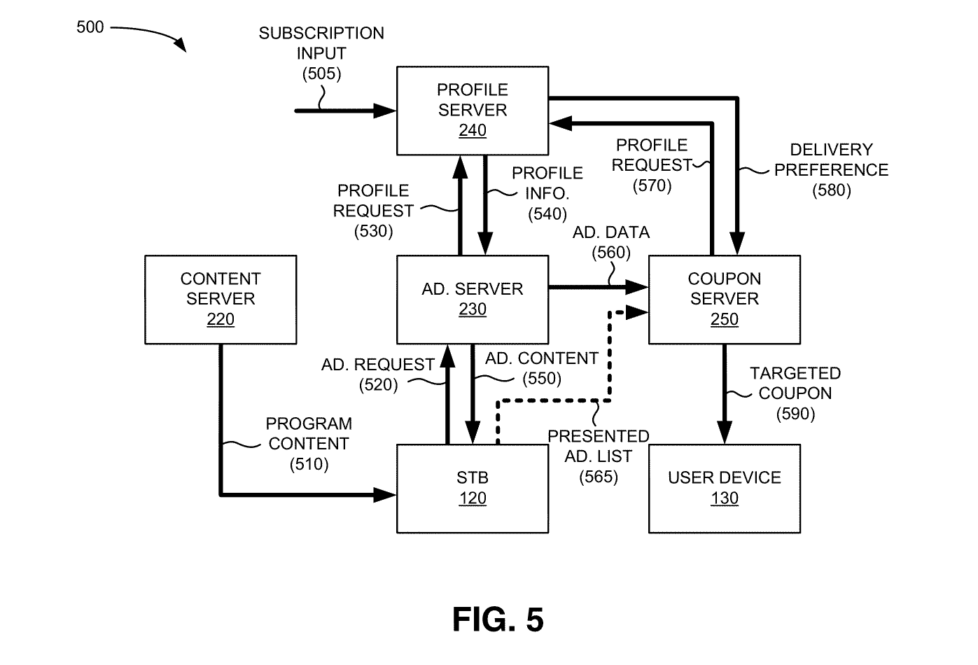

FIG. 5 depicts a diagram of exemplary interactions among components of an exemplary portion 500 of network 200. As illustrated, network portion 500 may include STB 120, user device 130, content server 220, advertising server 230, profile server 240, and coupon server 250. STB 120, user device 130, content server 220, advertising server 230, profile server 240, and coupon server 250 may include the features described above in connection with one or more of FIGS. 1-4. Interactions depicted in FIG. 5 may relate, for example, to coupon delivery in a system implementing targeted advertisement insertions at the device (e.g., STB 120) level.

Referring to FIG. 5, a user may subscribe to a coupon distribution service (e.g., offered via provider network 210). A subscription may be initiated, for example, via a telephone exchange with a service representative, an on-line transaction, a widget, etc. Based on information provided during the subscription process (or changed after the initial subscription), subscription input 505 may be provided to profile server 240 and stored for later use.

Content server 220 may provide program content 510 to STB 120 (e.g., in response to a tuning request from STB 120). Program content 510 may include, for example, linear content with embedded breaks for advertising. In some instances, program content 510 may include additional data, such as cue tones, so that targeted advertisements may be inserted into the advertising breaks in program content 510. STB 120 may receive program content 510 and may submit an advertisement request 520 to advertising server 230 to retrieve particular advertising content for insertion into the advertising breaks in program content 510. For example, in one implementation STB 120 may include a client application that manages local advertisement insertion. Advertisement request 520 may include, for example, information identifying the STB 120 (e.g., a unique STB identifier), advertisement requirements (e.g., duration), profile information, and/or an account identifier (e.g., if STB 120 is configured to manage multiple user accounts).

Advertising server 230 may receive advertisement request 520 and, in response, generate a profile request 530 to profile server 240. Profile request 530 may identify a user associated with STB 120 (e.g., based on the unique STB identifier or account identifier from advertisement request 520) and may request profile information associated with STB 120. Profile server 240 may receive profile request 530, and may retrieve (e.g., from a profile database, not shown) profile information 540. Profile information 540 may include, for example, location information, age, and/or other demographic information that may be relevant to selecting particular advertising targeted for STB 120.

Advertising server 230 may receive profile information 540 and may select, based on advertisement request 520 and profile information 540, appropriate targeted advertising content. For example, advertising server 230 may use advertising metadata to match particular duration and profile criteria. In one implementation, targeted advertising content may include a single advertisement or set of advertisements for a particular upcoming advertising break in program content 510. In another implementation, targeted advertising content may include a block of advertisements from which individual advertisements may be selectively inserted (e.g., by STB 120) over multiple advertising breaks. Advertising server 230 may forward the targeted advertising content to STB 120 as advertising content 550.

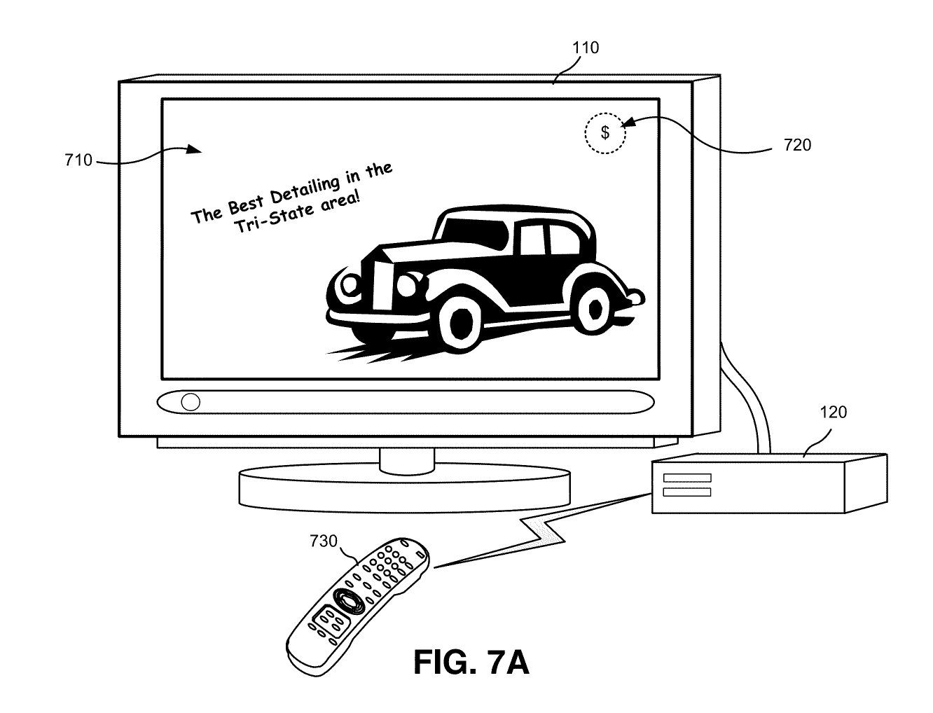

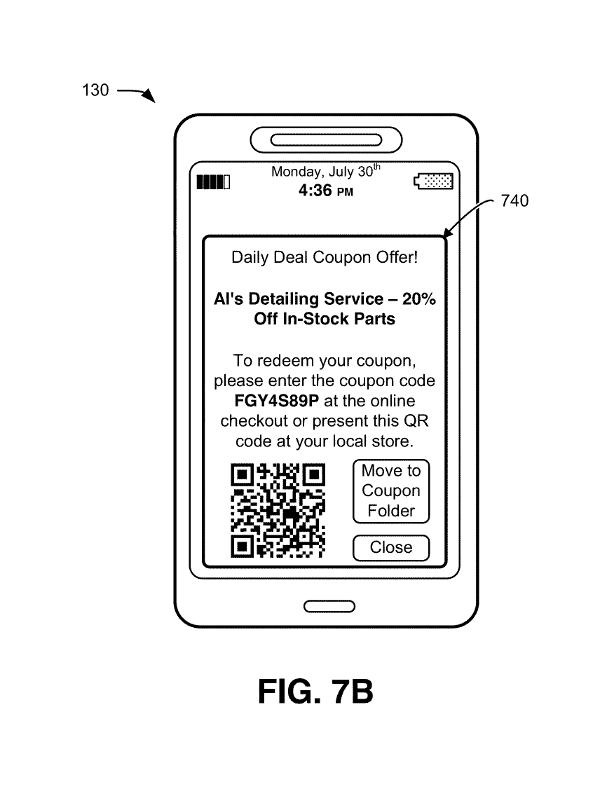

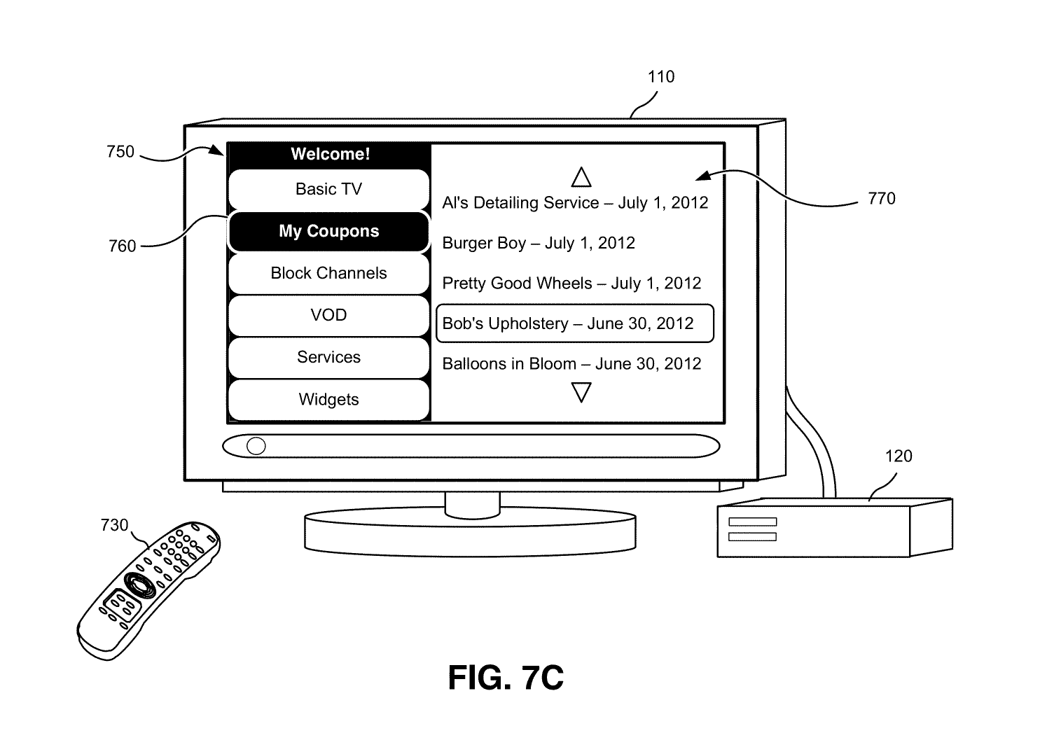

STB 120 may receive advertising content 550 and may insert some or all of advertising content 550 into an advertising break of program content 510 for presentation on display 110. If advertising content 550 includes a block of advertisements, STB 120 may selectively insert individual advertisements based on, for example, profile matching, durations, and/or cyclical insertions (e.g., random or round-robin cycles). In one implementation, STB 120 may include an overlay or other indicator to signal to a user that a particular advertisement is associated with a coupon distribution program. Coupon indicators are described further in connection with FIG. 7A.

In one implementation, advertising server 230 may provide, to coupon server 250, advertising data 560. Advertising data 560 may include, for example, a list of targeted advertisements provided to STB 120 (e.g., including a unique identifier for each particular advertisement) and a unique STB identifier (or user account identifier) for the recipient STB. In another implementation, advertising data 560 may be compiled by advertising server 230 based on communications (not shown) with STB 120 and/or content server 220. Advertising data 560 may be provided, for example, in real-time, at various intervals, or upon request from coupon server 250.

Alternatively, or additionally, STB 120 may log advertising that is inserted into program content 510 and may provide a presented advertisement list 565 to coupon server 250. Presented advertisement list 565 may include information similar to advertising data 560. However, presented advertisement list 565 may include, for example, only advertisements actually presented to (or viewed by) the viewer. For example, STB 120 may log only items from advertising content 550 that are presented for all or a particular portion of the advertisement duration. Thus, if a viewer selects a different channel during an advertising break in program content 510, presented advertising list 565 would not include advertising segments from advertising content 550 that were not actually presented (or presented for at least a certain period) to the viewer.

Coupon server 250 may receive advertising data 560 and/or presented advertisement list 565. In response, coupon server 250 may submit a profile request 570 to profile server 240. Profile request 570 may include, for example, the unique STB identifier (or another cross-referenced identifier based on the unique STB identifier or account identifier) associated with advertising data 560 or presented advertisement list 565. In response to profile request 570, profile server 240 may identify a coupon delivery preference associated with STB 120. The coupon delivery preference may include account information, such as an email address, a phone number, an account identifier (e.g., Twitter, Facebook, etc.), etc., that may be used to deliver digital coupons to a user associated with STB 120. Coupon delivery preferences may be provided, for example, by a user at the time of registering for the coupon distribution program. Profile server 240 may match the user information in profile request 570 to the appropriate account information and provide coupon delivery information to coupon server 250 as delivery preference 580.

Based on advertising data 560 and/or presented advertisement list 565, coupon server 250 may identify if a coupon offer may be associated with one or more of the advertisements from advertising data 560 and/or presented advertisement list 565. For example, coupon server 250 may match advertising metadata received from advertising server 230 and/or STB 120 with stored coupon content (e.g., coupon metadata) to identify if an appropriate coupon offer is available. If coupon server 250 finds a matching coupon offer, coupon server 250 may apply delivery preference 580 and may send targeted coupons 590 to a user device 130 associated with delivery preference 580. For example, if delivery preference 580 includes an email address, coupon server may provide targeted coupons 590 via an email message that may be retrieved on user device 130 (or another device with access to the user's email account).

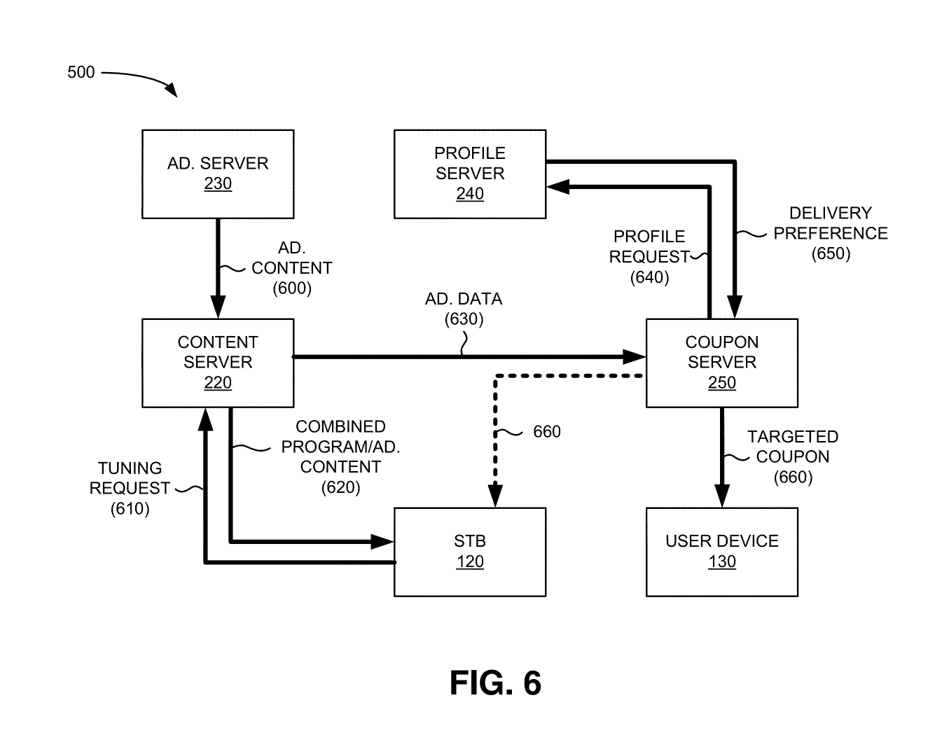

FIG. 6 depicts another diagram of other exemplary interactions among components of network portion 500. Interactions depicted in FIG. 6 may relate, for example, to coupon delivery in a system implementing regional advertisement insertions. As shown in FIG. 6, advertising server 230 may provide advertising content 600 to content server 220. Advertising content 600 may include, for example, local/regional advertising for a particular geographical area that may be inserted into linear program content during particular advertising breaks.

STB 120 may receive a channel selection for available television content from a user (e.g., via a remote control) and may provide a tuning request 610 to content server 220. Tuning request 610 may identify a particular channel and unique identifier for STB 120. In response to tuning request 610, content server 220 may provide the requested program content to STB 120. In some instances, content server 220 may insert advertisements from advertising content 600 into advertising breaks in the program content so that combined program and advertising content 620 is provided to STB 120. STB 120 may receive combined program and advertising content 620 for presentation to a viewer.

Content server 220 may be made aware of particular accounts/STBs that have opted into the coupon distribution program provided by provider network 210. Content server 220 may log the channel included in tuning request 610 and track which advertisements from advertising content 600 are provided to STB 120 in combined program and advertising content 620. In one implementation, content server 220 may provide, to coupon server 250, advertising data 630. Advertising data 630 may include, for example, a list of advertisements provided to STB 120 and the unique STB identifier (or user account identifier) for STB 120. Advertising data 630 may be provided, for example, in real-time, at various intervals, or upon request from coupon server 250.

Coupon server 250 may receive advertising data 630 and, in response, may submit a profile request 640 to profile server 240. Profile request 640 may include, for example, the unique STB identifier of STB 120. In response to profile request 640, profile server 240 may identify a coupon delivery preference associated with STB 120. The coupon delivery preference may include account information that may be used to deliver digital coupons to a user associated with STB 120. Coupon delivery preferences may be provided, for example, by a user at the time of registering for the coupon distribution program and stored in profile server 240. Profile server 240 may match the user information in profile request 570 to the appropriate account information and provide coupon delivery information to coupon server 250 as delivery preference 650.

Based on advertising data 630, coupon server 250 may identify if a coupon offer may be associated with one or more of the advertisements from advertising data 630. For example, coupon server 250 may match advertising metadata received from advertising server 230 and/or STB 120 with stored coupon content (e.g., coupon metadata) to identify if an appropriate coupon offer is available. If coupon server 250 finds a matching coupon offer, coupon server 250 may apply delivery preference 650 and may send targeted coupons 660 to user device 130 associated with delivery preference 650. For example, if delivery preference 650 includes a phone number, coupon server may provide targeted coupons 660 via an SMS message that may be retrieved on user device 130 (or another device with access to the user's phone messages). Coupon presentation via user device 130 is described further in connection with FIG. 7B. Additionally, or alternatively, targeted coupons 660 may be provided to STB 120 for presentation on display 110. Coupon presentation via STB 120 is described further in connection with FIG. 7C.

Although FIGS. 5 and 6 show exemplary components of network portion 500, in other implementations, network portion 500 may include fewer, different, differently-arranged, or additional functional components than those depicted in FIGS. 5 and 6. Alternatively, or additionally, one or more components of network portion 500 may perform one or more other tasks described as being performed by one or more other components of network portion 500.

FIGS. 7A-7C are exemplary diagrams illustrating implementations of user interfaces for targeted coupon delivery. More specifically, FIG. 7A provides an exemplary diagram of an on-screen television display that includes a notification of a customized promotion within a television advertisement. FIG. 7B provides an exemplary diagram of a user device presenting a targeted digital coupon. FIG. 7C provides an exemplary diagram of an on-screen television display that includes a user interface of reviewing a user's digital coupons.

Referring to FIG. 7A, STB 120 may cause display 110 to present a television advertisement 710 (e.g., during a commercial break of a program). In one implementation, the television advertisement 710 may include a coupon indicator 720. Coupon indicator 720 may include, for example, an indication within television advertisement 710 or an overlay inserted on top of television advertisement 710. As an overlay, coupon indicator 720 may be inserted, for example, by STB 120 as an indication that a coupon offer is associated with television advertisement 710. In this instance, coupon indicator 720 may provide a generic indicator that a coupon offer may be associated with the advertiser. For example, in one implementation, STB 120 may insert coupon indicator 720 on any advertisement that is a local (e.g., targeted) advertisement inserted by STB 120 into a program content stream. In another implementation, television advertisement 710 may include metadata to indicate to STB 120 that a corresponding coupon offer is available. The metadata may trigger STB 120 to present coupon indicator 720 for the particular television advertisement.

In still another implementation, coupon indicator 720 may include an interactive component, such as an EBIF interface. In this instance a user may use a remote control 730 to register interest in coupon indicator 720 during television advertisement 710. Receiving an appropriate remote control signal may cause STB 120 to flag television advertisement 710 for inclusion in a list of advertisements for which to provide digital coupons (e.g., presented advertisement list 565).

Referring to FIG. 7B, user device 130 may receive (e.g., from coupon server 250) a digital coupon 740 based on information received from STB 120, content server 220, and/or advertising server 230. For example, based on a logged presentation of television advertisement 710 (e.g., presented advertisement list 565), user device 130 may receive digital coupon 740 relating to the content and/or sponsor of television advertisement 710. Digital coupon 740 may include, for example, text for redemption of coupon 740, a quick response (QR) code, and/or other information.

Referring to FIG. 7C, in another implementation, display 110/STB 120 may present to a viewer a list of coupons available to the viewer via a coupon distribution program. For example, STB 120 may receive an indication of a digital coupon (e.g., targeted coupons 660) and may store the coupon with a memory (e.g., main memory 330). STB 120 may present an option screen, such as a welcome screen 750, that includes multiple navigation options for a viewer to select using remote control 730. One option of welcome screen 750 may include a “my coupons” option 760. Selection of “my coupons” option 760 may cause STB 120 to present a listing 770 of coupons that are available to the designated recipient of the coupon distribution program. In one implementation, listing 770 may include a selectable list with links to the text of each particular coupon. In another implementation, listing 770 may include information about each particular coupon, such as the date/time of coupon delivery (e.g., to an account associated with user device 130). In still another implementation, listing 770 may include links to invoke an advertisement pertaining to particular coupons. Thus, listing 770 may provide an opportunity to view an advertisement (e.g., pertaining to a coupon) on-demand.

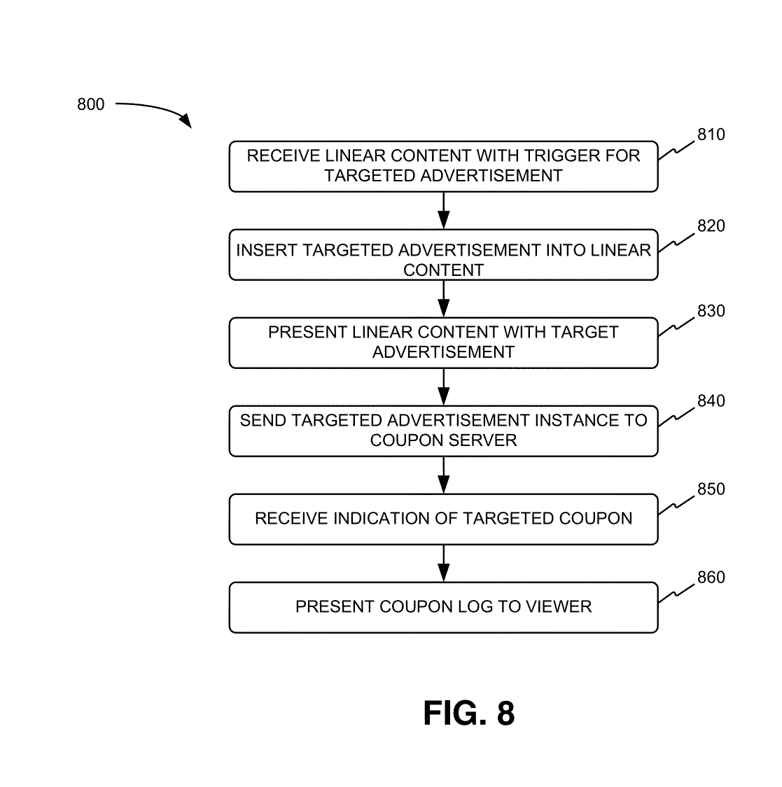

FIG. 8 is a diagram of an exemplary process 800 for providing information to support delivery of targeted coupons. In one implementation, process 800 may be performed by STB 120. In another implementation, some or all of process 800 may be performed by another device or group of devices, including or excluding STB 120. For example, content server 220 and/or advertising server 230 may perform one or more parts of process 800.

As shown in FIG. 8, process 800 may include receiving linear content with a trigger for a targeted advertisement (block 810), inserting a targeted advertisement into the linear content (block 820), and presenting the linear content with the targeted advertisement (block 830). For example, as described above in connection with FIG. 5, STB 120 may receive program content 510 from content server 220 and may submit an advertisement request 520 to advertising server 230 to retrieve particular advertising content for insertion into the advertising breaks in program content 510. STB 120 may receive advertising content 550 and may insert some or all of advertising content 550 into an advertising break of program content 510 for presentation on display 110.

Process 800 may also include sending a targeted advertisement instance to a coupon server (block 840). For example, as described above in connection with FIG. 5, STB 120 may log advertising that is inserted into program content 510 and may provide a presented advertisement list 565 to advertising server 230 and/or coupon server 250. Presented advertisement list 565 may include, for example, only advertisements actually presented to the viewer.

Process 800 may further include receiving an indication of a targeted coupon delivery (block 850) and presenting a coupon log to a viewer (block 860). For example, as described above in connection with FIG. 6, coupon server 250 may provide targeted coupons 660 to STB 120. Targeted coupons 660 may be provided to STB 120 for presentation on display 110, using, for example, the user interface shown in FIG. 7C.

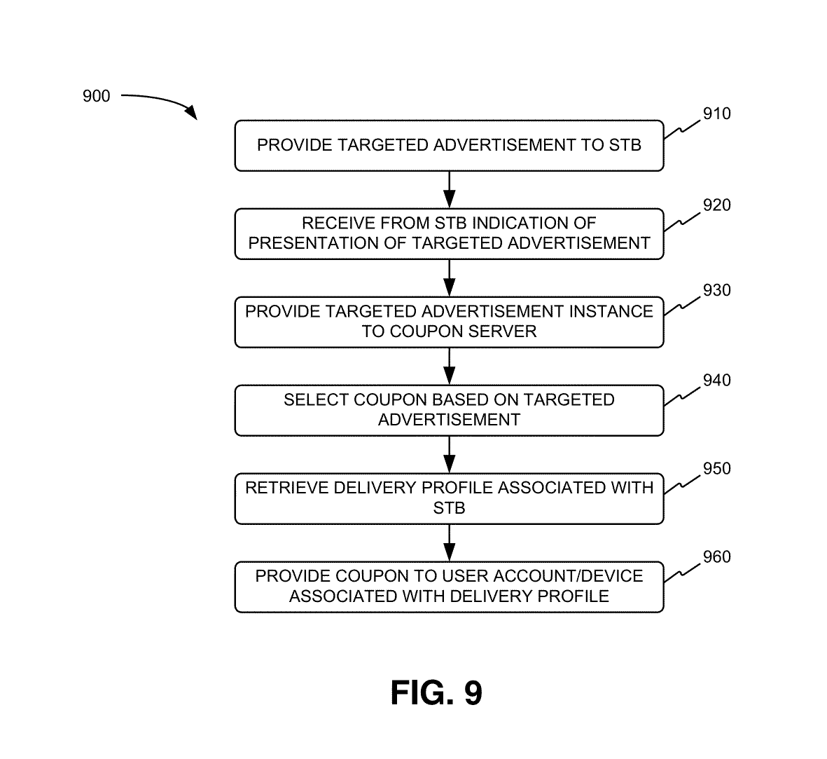

FIG. 9 is a diagram of an exemplary process 900 for providing targeted coupons to user device 130. In one implementation, process 900 may be performed by advertising server 230 and coupon server 250. In another implementation, some or all of process 900 may be performed by another device or group of devices, including or excluding advertising server 230. For example, STB 120 and/or content server 220 may perform one or more parts of process 900.

As shown in FIG. 9, process 900 may include providing targeted advertisements to an STB (block 910), and receiving an indication of presentation of the targeted advertisement (block 920), and providing a targeted advertising instance to a coupon server (block 930). For example, as described above in connection with FIG. 5, advertising server 230 may forward the targeted advertising content to STB 120 as advertising content 550. Targeted advertising content may include a single advertisement or a block of advertisements. Advertising server 230 may provide, to coupon server 250, advertising data 560, such as a list of targeted advertisements provided to STB 120 and a unique STB identifier (or user account identifier) for the recipient STB. In another implementation, advertising data 560 may be compiled by advertising server 230 based on communications (not shown) with STB 120 and/or content server 220.

Process 900 may also include selecting a coupon based on the targeted advertisement (block 940) and retrieving a delivery profile associated with the STB (block 950). For example, as described above in connection with FIG. 5, based on advertising data 560 and/or presented advertisement list 565, coupon server 250 may identify if a coupon offer is associated with one or more of the advertisements from advertising data 560 and/or presented advertisement list 565. Assuming a coupon is identified, coupon server 250 may submit a profile request 570 to profile server 240 to determine a coupon delivery preference associated with STB 120. Coupon server 250 may receive coupon delivery preference 580, which may include account information, such as an email address or a phone number that may be used to deliver digital coupons to a user associated with STB 120.

Process 900 may further include providing the coupon to a user account/device associated with the delivery profile (block 960). For example, as described above in connection with FIG. 5, coupon server 250 may apply delivery preference 580 and may send targeted coupons 590 to a user device 130 associated with delivery preference 580. Additionally, as described above in connection with FIG. 6, targeted coupons 660 may be provided to STB 120 for presentation on display 110.

As described above, systems and/or methods described herein may track presentation of television advertising to identify and provide relevant coupons to users. The systems and/or methods may improve coupon offer response rates by ensuring that consumers have some familiarity with a particular merchant before the consumer receives a coupon from the particular merchant.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while a series of blocks has been described with respect to FIGS. 8 and 9, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

1. A method, comprising:
receiving, by a computing device, tracking information of a plurality of television advertisements presented to a user of a particular set-top box (STB), wherein the tracking information includes an STB identifier for the particular STB and a television advertisement identifier for each television advertisement of the plurality of television advertisements;
comparing, by the computing device, the received television advertisement identifiers to stored television advertisement identifiers that correspond to coupon content in a group of stored coupon content;
determining, by the computing device, that a received television advertisement identifier matches a stored television advertisement identifier;
identifying, by the computing device, coupon content corresponding to the stored television advertisement identifier;
obtaining, by the computing device and based on receiving the STB identifier, delivery preferences for the coupon content; and
sending, by the computing device and based on the delivery preferences, the coupon content to a user device associated with the particular STB.

2. (canceled)

3. The method of claim 1, wherein the tracking information includes an indication, from the particular STB, that each television advertisement was presented to the user.

4. The method of claim 1, wherein the tracking information includes an indication, from a network device in a provider network, that each television advertisement was provided to the particular STB for presentation to the user.

5. The method of claim 1, further comprising:
identifying, based on a profile associated with the particular STB, a targeted advertisement to include in the plurality of television advertisements; and
providing, to the STB, the targeted advertisement for insertion into a selected programming stream.

6. The method of claim 1, further comprising:
receiving, prior to the identifying, user configuration information including the delivery preferences.

7. The method of claim 1, further comprising:
sending at least a portion of the coupon content to the particular STB for presentation to the user.

8. The method of claim 1, wherein the coupon content includes a discount offer from a merchant associated with a television advertisement corresponding to the received television advertisement identifier.

9. The method of claim 1, wherein each television advertisement includes a selection interface to indicate user interest in a coupon associated with the television advertisement, and
wherein the tracking information includes indication of a user response.

10. The method of claim 1, wherein the delivery preferences include one or more of:
an email address,
a phone number, or
an account identifier.

11. A computing device, comprising:
a network interface to communicate with one or more remote systems;
one or more memories to store instructions; and
one or more processors configured to execute instructions in the one or more memories to:
receive tracking information of a plurality of television advertisements presented to a user of a particular set-top box, wherein the tracking information includes a television advertisement identifier for each television advertisement of the plurality of television advertisements,
compare the received television advertisement identifiers to stored television advertisement identifiers that correspond to coupon content in a group of stored coupon content;
determine that a particular received television advertisement identifier matches a particular stored television advertisement identifier,
identify, from the group of stored coupon content, particular coupon content corresponding to the particular stored television advertisement identifier, and
send, based on stored delivery preferences, the particular coupon content to a user device associated with the set-top box.

12. The computing device of claim 11, wherein the one or more processors are further configured to:
obtain the stored delivery preferences for the particular coupon content.

13. The computing device of claim 11, wherein the tracking information is received from one of:
the particular set-top box, or
a network device in a provider network.

14. The computing device of claim 11, wherein the tracking information further includes:
a unique identifier for the particular set-top box.

15. The computing device of claim 11, wherein the one or more processors are further configured to:
receive user configuration information including the delivery preferences.

16. The computing device of claim 11, the one or more processors are further configured to:
send at least a portion of the coupon content to the particular set-top box.

17. The computing device of claim 11, wherein the particular coupon content includes a discount offer from a merchant associated with a television advertisement corresponding to the particular received television advertisement identifier.

18. A non-transitory computer-readable medium comprising computer-executable instructions, the computer-readable medium comprising one or more instructions to:
retrieve tracking information of a plurality of television advertisements presented via a particular set-top box, wherein the tracking information includes a television advertisement identifier associated with each television advertisement of the plurality of television advertisements;
compare the received television advertisement identifiers to stored television advertisement identifiers that correspond to coupon content in a group of stored coupon content;
determine that a particular received television advertisement identifier matches a particular stored television advertisement identifier;
identify, from the group of stored coupon content, particular coupon content corresponding to the particular stored television advertisement identifier; and
send the particular coupon content to a user device associated with the set-top box.

19. The computer-readable medium of claim 18, wherein the tracking information further includes:
a unique identifier for the particular set-top box.

20. The computer-readable medium of claim 18, further comprising one or more instructions to:
store delivery preferences, for the user device associated with the particular set-top box, to send the particular coupon content.
